(19) United States
(12) Patent Application Publication
(10) Pub. No.: US 2013/0215469 A1
(43) Pub. Date: Aug. 22, 2013

(54) SYSTEMS AND METHODS FOR SCANNING

(71) Applicants: Laurent Pizot, Camas, WA (US); Loren D. Chapple, Vancouver, WA (US); Teng Chai Lim, Singapore (SG); Hean Koon Koay, Singapore (SG); K S Venugopal, Bangalore (IN)

(72) Inventors: Laurent Pizot, Camas, WA (US); Loren D. Chapple, Vancouver, WA (US); Teng Chai Lim, Singapore (SG); Hean Koon Koay, Singapore (SG); K S Venugopal, Bangalore (IN)

(21) Appl. No.: 13/882,749

(22) PCT Filed: Dec. 20, 2010
(86) PCT No.: PCT/US10/61273

§ 371 Date: May 1, 2013

(51) Int. Cl. H04N 1/00

(52) U.S. Cl. CPC H04N 1/00244
USPC 358/1.15

(57) ABSTRACT

A scan request is received. In response, a command is sent to an image scanner to scan media. A scanned image of the media is received from the image scanner according to the command.

### BACKGROUND

An image scanner, or simply scanner, is a device that optically scans images, printed text, handwriting, objects, and other suitable media and converts the media into a digital image. Frequently, image scanners are connected to a local computer device which receives scanned images from the image scanner. Some image scanners include a variety of scanning features (e.g., image enhancement, size alteration, format conversion, etc.), while other image scanners have a limited number of scanning features.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a system according to various embodiments.

FIG. 2 is a block diagram illustrating a system according to various embodiments.

FIG. 3 is a flow diagram of operation in a system according to various embodiments.

FIG. 4 is a flow diagram of operation in a system according to various embodiments.

### DETAILED DESCRIPTION

Various embodiments described herein provide a scanning solution that allows media to be scanned and uploaded directly to a network storage device and/or to the “cloud”. As used herein, the “cloud” refers to Internet-based computing. In other words, a storage location in the cloud refers to a storage location that is connected to the Internet. In particular, various embodiments enable scanned images to be uploaded directly to an online storage server. Additionally, scanned images can be post-processed by a cloud computing infrastructure to provide additional scanner-related features not available directly on the image scanner.

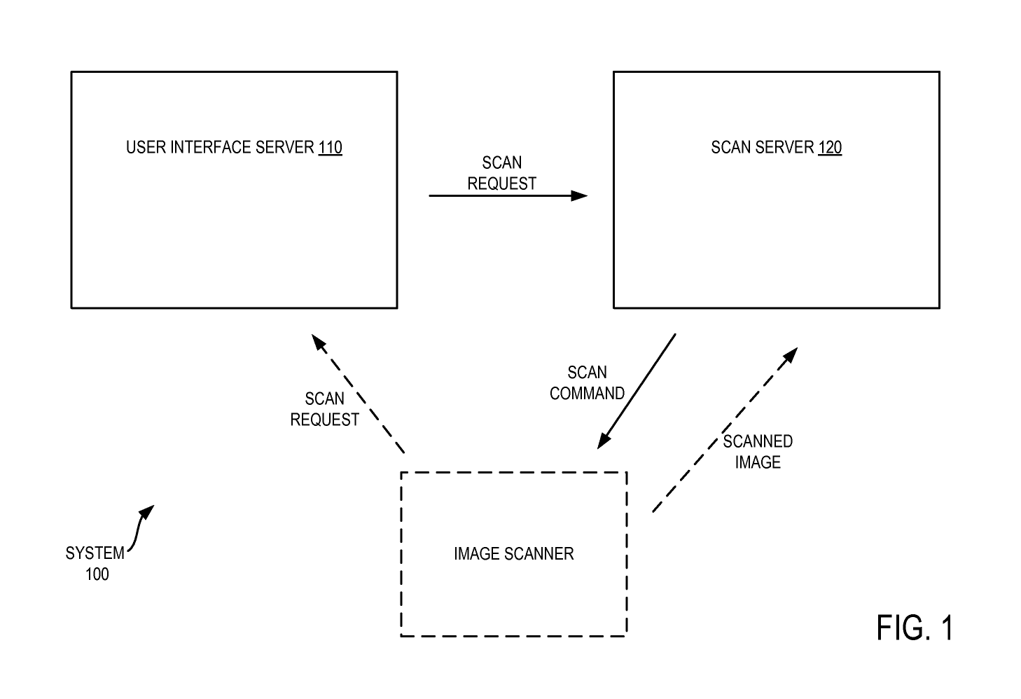

FIG. 1 is a block diagram illustrating a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules (e.g., stored on a computer-readable storage medium), hardware modules, special-purpose hardware (e.g., application specific hardware, application specific integrated circuits (ASICs), embedded controllers, hardwired circuitry, etc.), or some combination of these.

System 100 includes a user interface server 110 to receive a scan request initiated by a user. As shown in FIG. 1, the scan request can be initiated from an image scanner (e.g., via a user pressing a physical “scan” button on the image scanner or touching a “scan” button on a touchscreen display on the image scanner, etc.). In a traditional scanning device, initiation of a scan request from the image scanner typically directly causes the image scanner to scan media placed on the image scanner. However, in examples described herein, initiating a scan request causes the image scanner to send the scan request to user interface server 110. The image scanner and user interface server 110 may be connected over a network (e.g., via Ethernet, Wi-Fi, cellular communications, etc.). For example, user interface server 110 may be part of a cloud computing infrastructure and thus the image scanner can send the scan request to user interface server 110 via an Internet connection (e.g., using Hypertext Transfer Protocol (HTTP), HTTP Secure, or other suitable communication protocol).

User interface server 110 forwards the scan request to scan server 120 via a network connection (e.g. HTTPS or other suitable protocol). Similar to user interface server 110, scan server 120 might be part of a cloud computing infrastructure. In some embodiments, user interface server 110 and scan server 120 can be modules executing on the same hardware associated with a cloud computing infrastructure. In such embodiments, the scan request can be passed from user interface server 110 to scan server 120 internally (e.g., without the use of a network communication protocol).

In response to receiving the scan request, scan server 120 triggers the image scanner to perform a scan of media (e.g., images, printed text, handwritten documents, etc.). In other words, rather than scanning in direct response to the user initiating a scan request on the image scanner, scan server 120 triggers scanning by sending a command to the image scanner. Scan server 120 sends the command to the image scanner via XMPP (Extensible Messaging and Presence Protocol), although other suitable protocols may be used. After the image scanner performs the scan, it sends the scanned image back to scan server 120 using a suitable communications protocol. In some embodiments, the image scanner may start sending image scan data to scan server 120 prior to completing the scan. Scan server 120 receives the scanned image from the image scanner (e.g., via HTTP, HTTPS, etc.).

Accordingly, a single action from a user (e.g., initiating a scan request from the image scanner) results in an image scanner performing a scan and sending the scanned image to a destination via a network connection.

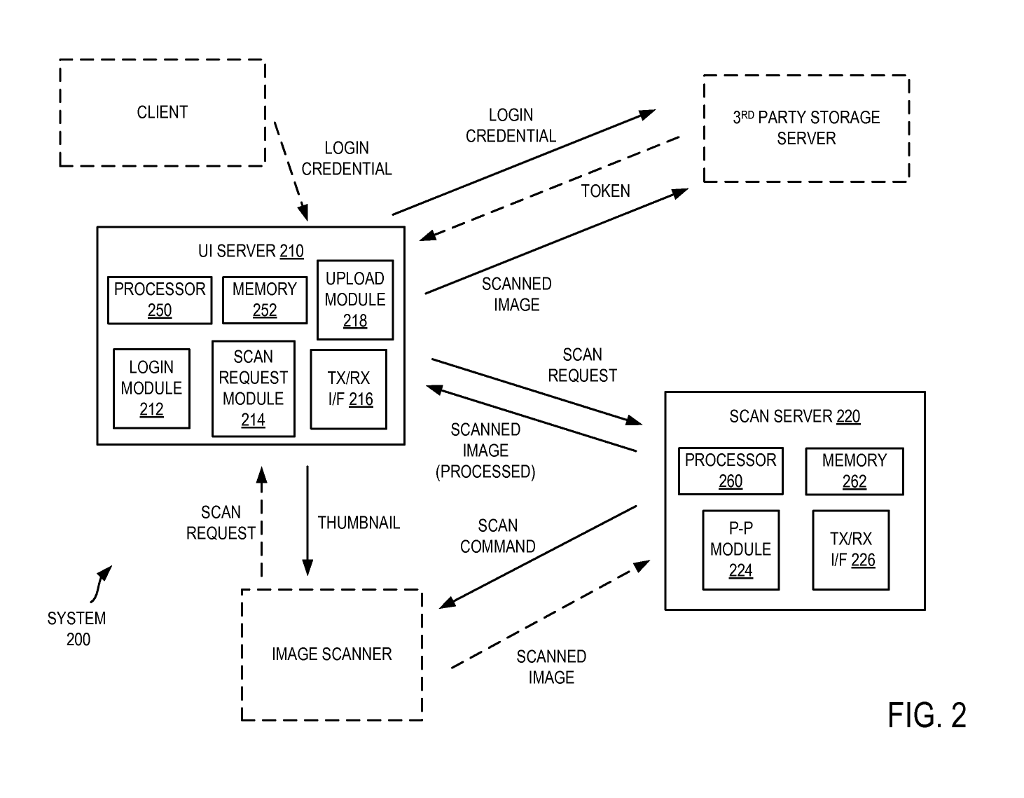

FIG. 2 is a block diagram of a system according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules (e.g., stored on a computer-readable storage medium), hardware modules, special-purpose hardware (e.g., application specific hardware, application specific integrated circuits (ASICs), embedded controllers, hardwired circuitry, etc.), or some combination of these.

System 200 includes a user interface server 210 and a scan server 220. User interface server 210 and scan server 220 are connected via a network using a communications protocol such as HTTPS. Other network communication protocols could be used in other embodiments. In addition, HTTPS or other suitable protocol could be used for communication with other devices illustrated in FIG. 2 (e.g., scanning device, client, 3^{rd} party storage server, etc.). While shown as separate servers, various functions and/or components of UI server 210 and scan server 220 could be combined into a single server in certain embodiments. In general, UI server 210 and scan server 220 may be part of a cloud computing infrastructure and can be distributed across multiple physical devices.

In various embodiments, UI server 210 hosts various printing and/or scanning applications, widgets, and/or “apps” available to a user. Such applications may be accessed by a user directly on the image scanner or via a web browser on a client device. In one example, a user may desire to access a file archiving application (e.g., from a user interface on the image scanner) that allows the user to scan media and archive the scanned image to a storage server (e.g., a 3^{rd} party storage server). To access the storage server, login module 212 receives a login credential via receiver interface 216. The login credential may be received directly from a user (e.g., via network connection from a client, the image scanner, etc.) or the login credential could be stored locally (e.g., on the image scanner) and sent automatically to UI server 210 in conjunction with the user accessing the file archiving application on the image scanner. Transmission interface 216 sends the login credential to the storage server in exchange for a token. The token could be a temporary token (e.g., session token) or it could be a permanent token which could then be stored, for example, in memory 260.

In addition to providing a login credential, the user may select a storage server folder from within the file archiving application for storing the scanned image on the storage server. UI server 210 receives the folder selection and passes it to the storage server. The user may also select various configuration settings for the scanning operation. For example, the user may select image enhancements, size reduction, format conversion, or other configuration settings. Configuration settings are sent from UI server 210 to post-processing module 224 on scan server 220.

Once login credentials, folder selections, and/or configuration settings have been obtained, UI server 210 authorizes scan server 220 to trigger the scan on the image scanner. Scan server 220 triggers the image scanner to scan media by sending the image scanner a command (e.g., via XMPP) that includes a destination address (e.g., a uniform resource locator (URL), etc.) for sending the scanned image of the media. The image scanner may include a web-service client to handle the command. Accordingly, the image scanner sends the scanned image back to scan server 220 after completing the scan. In some embodiments, the image scanner may start sending image scan data to scan server 220 prior to completing the scan.

Depending on the selected configuration settings and the capabilities of the image scanner, post-processing module 224 processes the scanned image received from the image scanner. For example, post-processing module 224 may generate a thumbnail image from the scanned image, which can then be sent (e.g. via transmission interface 216 or 226) to a user interface (e.g., on the image scanner or user client device), allowing the user to preview the scanned image prior to uploading the scanned image to the storage server. Other post-processing examples include stitching multiple images to form a single PDF file, performing OCR (optical character recognition), and/or extracting information after performing OCR. Additionally, if the scanned media is a card reader, magnetic strip reader or other reader, post-processing module 224 processes the scanned image of the reader to extract and/or convert data. Post-processing operations performed by post-processing module 224 may be transparent to the user (e.g., the user selects settings, initiates the scan and gets the desired results without any visibility as to whether processing occurs on the image scanner or on scan server 220). In some embodiments, the user may receive feedback regarding the progress of post-processing operations (e.g., error messages, completion of processing, etc.).

Once any post-processing has been completed, UI server 210 obtains the (processed) scanned image and upload module 218 sends the scanned image and the previously obtained token to the storage server. The storage server stores the image, for example, in the selected folder associated with the user (e.g. a user account).

Various modules and/or components illustrated in FIG. 2 may be implemented as a computer-readable storage medium containing instructions executed by a processor (e.g., processor 250 or 260) and stored in a memory (e.g., memory 252 or 262).

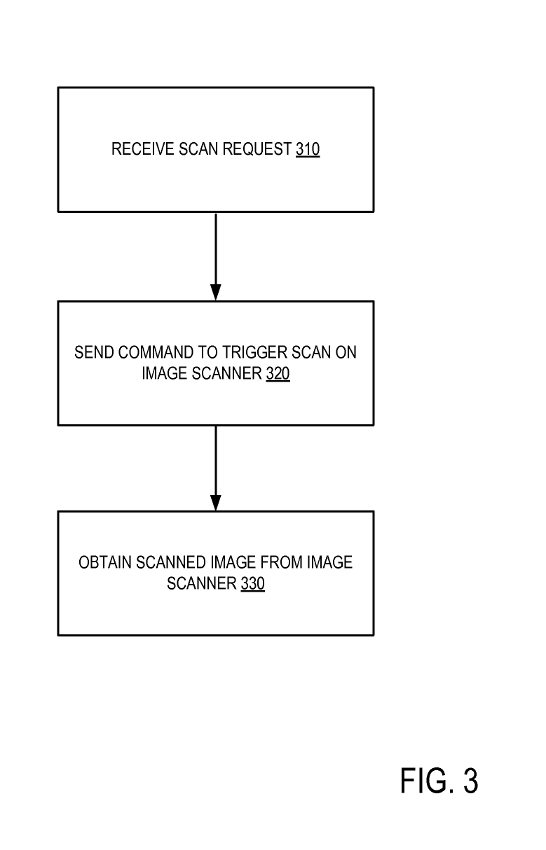

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A network server receives 310 a scan request for performing a scan on an image scanner. In various embodiments, the network server is a World Wide Web (WWW) server and/or part of a cloud computing infrastructure, although such association is not necessary. The scan request may include additional information including, but not limited to, desired configuration settings for the scan, login credentials, destination folder selection, etc.

In response to the scan request, a network server sends 320 a command to the target scanning device to trigger the image scanner to scan media (e.g., document, photo, image, object, etc.). The network server that sends the command may be the same physical device that received the scan request or it may be a different physical device. In the case of separate servers, scan requests are communicated from one server to another via a secure connection (e.g., HTTPS, etc.) over a network (e.g., Internet).

To trigger scanning on the image scanner, a command is sent to the image scanner via XMPP (or other suitable communication protocol). The trigger command may include a return address (e.g., uniform resource locator or URL) for sending the scanned image after completion of the scan. In some embodiments, the image scanner may start sending image scan data to scan server 120 prior to completing the scan.

A network server obtains 330 the scanned image from the image scanner. The network server that obtains the scanned image can be the same server that sent the trigger command or a different server. For example, many network servers might operate together as part of a cloud computing infrastructure where cloud computing tasks are distributed based on network loads, availability, etc.

Accordingly, as described, a scan request initiated by a user at an image scanner does not directly cause the image scanning device to scan media. Rather, the scan request is routed to a network server or cloud computing infrastructure and the scan is subsequently triggered from the network server or the cloud. The scanned image is sent back to the network server or to the cloud.

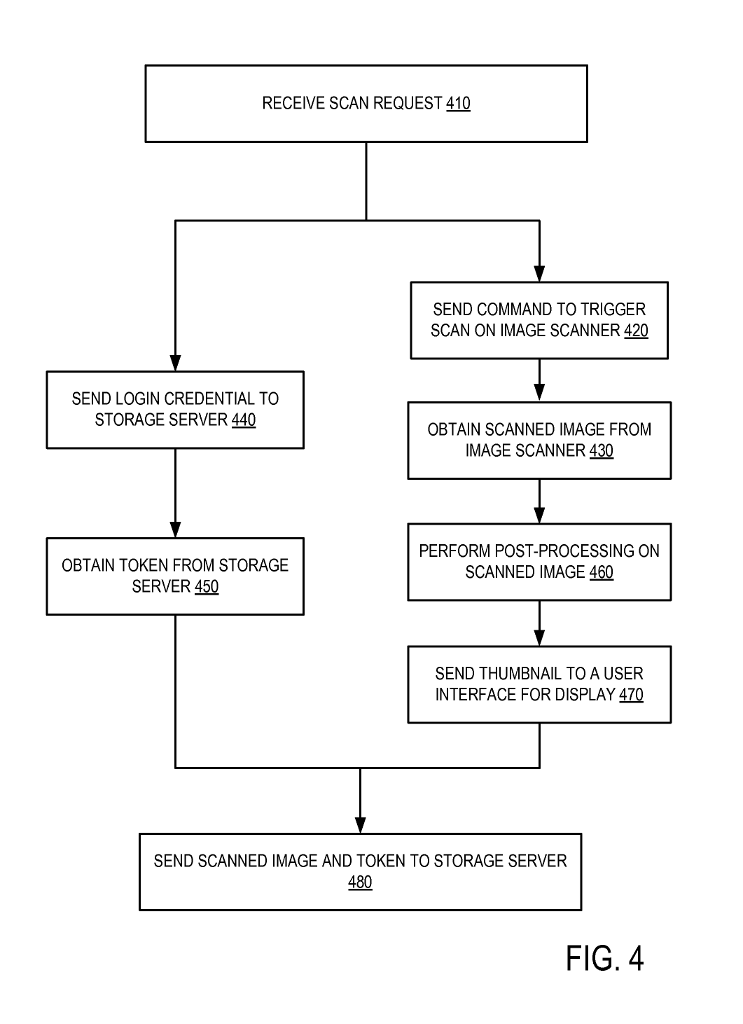

FIG. 4 is a flow diagram of operation in a system according to various embodiments. FIG. 4 includes particular operations and execution order according to certain embodiments. However, in different embodiments, other operations, omitting one or more of the depicted operations, and/or proceeding in other orders of execution may also be used according to teachings described herein.

A network server receives 410 a scan request for performing a scan on an image scanner. In various embodiments, the network server that receives the request is a WWW server and/or part of a cloud computing infrastructure, though such association is not necessary. The scan request may be received via HTTPS or other suitable communication protocol and may include additional information including, but not limited to, desired configuration settings for the scan, login credentials, destination folder selection, etc.

In response to the scan request, a network server sends 420 a command to the image scanner to trigger the image scanner to scan media (e.g., a document, photo, image, object, etc.). The network server that sends the command may be the same server that received the scan request or it may be a different server. In the case of separate servers, scan requests are communicated from one server to another via a communication protocol (e.g., HTTPS, etc.) over a network (e.g., Internet).

A trigger command is sent 420 to the image scanner via XMPP (or other suitable communication protocols). The trigger command may include a return address (e.g., URL) for sending the scanned image after completion of the scan. In some embodiments, the image scanner may start sending image scan data to the return address prior to completing the scan.

A network server obtains 430 the scanned image from the image scanner. The network server that obtains the scanned image can be the same server that sent the trigger command or a different server. For example, many network servers might operate together as part of a cloud computing infrastructure where cloud computing tasks are distributed based on network loads, availability, etc.

Post-processing is performed 460 on the scanned image at a network server according to workflow, application requirements and/or the desired configuration settings. For example, the user may desire to stitch multiple images together into a single PDF document, resize the scanned image, or perform OCR on the scanned image. Other image settings could also be selected. Depending on the image scanner, certain of the desired configuration settings may be performed by the image scanner prior to sending the scanned image to the network server. However, some or all of the image processing on the scanned image may be performed by a network server (e.g., associated with a cloud computing infrastructure). In other words, the image scanner may simply perform a raw scan of the media and send the scanned image to the scanning system (e.g., network server, cloud, etc.) where OCR, resizing, stitching, and/or other processing operations may be performed.

In various embodiments, a network server sends 470 a thumbnail version of the scanned image to a user interface for display. The user interface may be a user interface located on the image scanner, though it is not necessary that the user interface be located on the image scanner. The thumbnail image allows the user requesting the scan to preview the image prior to uploading the scanned image to a storage server. In certain embodiments, the user may reject the scanned image based on the preview and submit a repeat scan request.

In conjunction with receiving 410 the scan request, a network server associated with the scanning system obtains 440 a login credential for a storage server. For example, a user may seek to scan directly to Google Docs, offered by Google, Inc. of Mountain View, CA. To upload a scanned image to Google Docs, the user may provide his/her Google login credential to the scanning system upon request (e.g., via a user interface on a device with a network connection to the scanning system) or the login credential could be previously associated with the particular image scanner and maintained by the scanning system. In addition to obtaining the login credential, the scanning system may also obtain a specific destination folder selection from the user. The scanning system communicates the login credential (e.g., via HTTPS) to the storage server (e.g., Google) and obtains 450 a token from the storage server in return.

A network server associated with the scanning system sends 480 the scanned image, the token and any other additional information (e.g., destination folder for storing the scanned image) to the storage server where the scanned image is subsequently stored.

Various modifications may be made to the disclosed embodiments and implementations of the invention without departing from their scope. Therefore, the illustrations and examples herein should be construed in an illustrative, and not a restrictive sense.

1. A method, comprising:
receiving a scan request at a network server;
sending, in response to the scan request, a command from a network server to an image scanner to scan media; and
obtaining a scanned image of the media from the image scanner according to the command.

2. The method of claim 1, further comprising:
uploading the obtained scanned image to a storage server.

3. The method of claim 2, wherein uploading the received media scan to the storage server comprises:
sending a login credential to the storage server independent of the scan request;
obtaining a token from the storage server in response to sending the login credential; and
sending the scanned image and the token to the storage server.

4. The method of claim 1, further comprising:
generating a thumbnail image of the scanned image obtained from the image scanner; and
sending the thumbnail image to a user interface for display.

5. The method of claim 4, wherein the user interface is located on the image scanner.

6. The method of claim 1, wherein the scan request includes desired configuration settings for scanning the media.

7. The method of claim 6, further comprising:
performing post-processing on the scanned image obtained from the image scanner according to the configuration settings.

8. The method of claim 1, wherein the command sent to the image scanner includes a destination address for sending the scanned image.

9. A system, comprising:
a scan request module to obtain, via a network, a scan request initiated by a user;
a scan module to trigger, via the network, an image scanning device to scan media in response to the scan request;
the scan module to obtain, via the network, a scanned image of the media from the image scanning device.

10. The system of claim 9, further comprising:
an upload module to upload the obtained scanned image to a storage server.

11. The system of claim 9, further comprising:
a login module to send a login credential to a storage server;
an upload module to send the scanned image to the storage server with a token obtained from the storage server based on the login credential.

12. The system of claim 9, the scan server further comprising:
a post-processing module to generate a thumbnail image of the scanned image obtained from the image scanning device; and
a transmission interface to send the thumbnail image to a user interface for display.

13. The system of claim 9, the scan server further comprising:
a post-processing module to process the scanned image obtained from the image scanning device according to configuration settings received by the scan request module in conjunction with the scan request.

14. A computer-readable storage medium containing instructions, that when executed, cause a computer to:
receive a scan request from an image scanner;
send a command to the image scanner to cause the image scanner to scan media;
obtain a scanned image of the media from the image scanner;
perform processing operations on the scanned image according to selected configuration settings; and
upload the scanned image to a network storage server based on an access token for the network storage server.
